(19) United States
(12) Patent Application Publication
(10) Pub. No.: US 2025/0072385 A1
(43) Pub. Date: Mar. 6, 2025

(54) CAT LITTER BOX WITH A WASTE COLLECTION COMPARTMENT

(71) Applicant: FURRYTAIL PET CORP, CHINO HILLS, CA (US)

(72) Inventors: Xiangtian Duan, Hangzhou (CN); Shuning Lian, Hangzhou (CN)

(21) Appl. No.: 18/821,474

(22) Filed: Aug. 30, 2024

(30) Foreign Application Priority Data
Aug. 31, 2023 (CN) 202322357001.9

(51) Int. Cl. A01K 1/01

(52) U.S. Cl. CPC A01K 1/0114

(57) ABSTRACT

The present utility model discloses a cat litter box with a waste collection compartment including a waste compartment lid and a waste compartment body, in which the waste compartment lid is an arc-shaped lid plate and is movably connected to the waste compartment body, the waste compartment body is a cavity having a hollow inside, a waste entrance is provided in the waste compartment body, has a rounded rectangular shape, and is covered with a waste compartment door, one end of the waste compartment door is fixed to one end of the waste entrance, the other end of the waste compartment door is naturally fitted with the other end of the waste entrance due to the gravity, protruding fins are provided on left and right sides of the waste compartment door, and a magnetic attraction ring is sleeved on outer edges of the two fins.

### FIELD OF THE INVENTION

The present utility model relates to the technical field of pet products, and in particular to a cat litter box with a waste collection compartment.

### BACKGROUND OF THE INVENTION

As living standards are continuously improved, more and more families choose pets as daily companions, especially in economically developed cities, a proportion of people raising pets is higher. However, due to a per capita housing area and a control on pets going out in the economically developed cities, more pet-raising populations prefer cats that do not require too much activity area. Feline pets need special cat litter for waste, and the cat litter needs to be cleaned regularly. However, when an owner is out and cannot clean the waste in time, hygiene of a cat litter box becomes poor, and health of the cat is further affected.

A cat litter box is a container for cats to defecate and go to the toilet. The cat litter box is usually made of plastic or other easy-to-clean materials and has edges to prevent cat litter from spilling. A cat owner pours the cat litter into the cat litter box where cats can squat and defecate. Using a cat litter box helps keep a home environment clean and gives cats a designated area to go to the toilet. It is important to clean the cat litter box regularly to ensure hygiene and comfort.

There are two main defects in a cat litter box in the related art. First, when a waste bag is sleeved in a waste compartment, a bag opening is usually open and faces outward, so that an owner always sees the bag full of waste when cleaning the waste compartment and replacing the waste bag, which affects the look and feel. Second, since sealing of the waste compartment is not good, smell of the waste compartment leaks to the outside, which affects a user experience.

### SUMMARY OF THE INVENTION

The present utility model designs a novel cat litter box in view of two defects of the cat litter box in the description of the related art, and an object thereof is to reduce odor overflow and improve an experience of cleaning waste by improving a waste collection compartment.

A technical solution employed in the apparatus relates to a waste collection compartment, including: a waste compartment lid; and a waste compartment body, in which the waste compartment lid is an arc-shaped lid plate and is movably connected to the waste compartment body, the waste compartment body is a cavity having a hollow inside, a waste entrance is provided in the waste compartment body, has a rounded rectangular shape, and is covered with a waste compartment door, one end of the waste compartment door is fixed to one end of the waste entrance, the other end of the waste compartment door is naturally fitted with the other end of the waste entrance due to the gravity, protruding fins are provided on left and right sides of the waste compartment door, and a magnetic attraction ring is sleeved on outer edges of the two fins.

Preferably, each of the fins is a triangular plastic sheet with a protruding middle and concave ends, and a bottom edge of the fin coincides with an edge contour line of the waste compartment door.

Preferably, a thickness of the waste compartment door is 5 mm to 6 mm.

Preferably, triangular sheets are provided on both sides of the waste compartment lid, and when the waste compartment lid is closed, the triangular sheets are pressed into both sides of the waste compartment body and pressed against the magnetic attraction ring.

Preferably, a plurality of protrusions are provided on the waste compartment lid, and when the waste compartment lid is closed, these protrusions are pressed against the magnetic attraction ring.

Preferably, the magnetic attraction ring is made of ABS plastic material and includes a magnet inside.

The present utility model further relates to a cat litter box, including: a base; a cat compartment; a litter collection space; and the above-described waste collection compartment, in which the waste collection compartment is located obliquely above the cat compartment.

Preferably, the cat compartment and the waste collection compartment are connected by a channel partition.

Compared with the related art, the apparatus has the following beneficial effects.

(1) When a waste bag is sleeved in the waste compartment, two openings at ends of the waste bag are first covered over an inner side of the magnetic attraction ring, and then the magnetic attraction ring is sleeved on the edges of the two fins to press the waste bag, so that the openings of the waste bag are not exposed. When the cat litter box is cleaned and the waste is collected, the waste enters the waste bag through the waste compartment door, and due to a position limiting effect of the magnetic attraction ring on the waste bag, the openings of the waste bag are not greatly displaced. After the cleaning in this way, the openings of the waste bag can still be guaranteed to always face the inside of the waste compartment, and when an owner opens the waste compartment to take out the waste bag, the owner does not directly see the waste inside the waste compartment, so that a user experience is improved.

(2) There are two main ways for a gas exchange between the waste compartment and the outside. The gas inside the waste compartment either flows toward the waste compartment lid or moves toward the waste compartment door. In the design of the present apparatus, sealing of the waste compartment lid when the waste compartment lid is closed is strengthened, the magnetic attraction ring presses the openings of the waste bag, the protrusions on the waste compartment lid press against the magnetic attraction ring when the waste compartment lid is closed, so that the overflow of odor is minimized as much as possible. In addition, the thickness of the waste compartment door is designed to be 5 mm to 6 mm (the thickness of the waste compartment door on the market is mainly designed to be 2 mm to 3 mm), and the waste compartment door having such a thickness can served as a counterweight, can ensure that the waste compartment door has enough strength to push the bag openings for normal opening and closing when the litter is filtered and the waste is collected, and can also block the odor by the thickened door body. The overflow of odor is minimized as much as possible by various design means. Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference similar features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a schematic diagram of a magnetic attraction ring without being sleeved on fins of a waste collection compartment according to an embodiment.

FIG. 2 is a schematic diagram of the magnetic attraction ring sleeved on the fins.

FIG. 3 is a schematic diagram of a cat litter box with the waste collection compartment according to the present embodiment.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phrascology used is for the purpose of describing exemplary embodiments and should not be considered limiting. Thus, the present invention is to be accorded the widest scope encompassing numerous alternatives, modifications and equivalents consistent with the principles and features disclosed. For clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

Regarding applicability of 35 U.S.C. § 112, 96, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification comprises references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

In order to make the above-described object, features, and advantages of the present utility model more obvious and easy to understand, embodiments of the present utility model will be described in detail below with reference to the accompanying drawings. In the following description, many specific details are described to facilitate a full understanding of the present utility model. However, the present utility model can be implemented in many other ways different from those described herein, and those skilled in the art can make similar improvements without violating the connotation of the present utility model. Therefore, the present utility model is not limited by the embodiments disclosed below.

The embodiments will be described below with reference to the accompanying drawings to further describe the embodiments of the present utility model in detail, and an object is to help those skilled in the art to further completely, accurately, and deeply understand a concept and technical solutions of the present utility model and to facilitate the implementation. It should be noted that in the following embodiments, terms “above”, “below”, “left”, “right”, “top”, and “bottom” do not represent an absolute distinction in a structure and/or a function, but are only for the convenience of description.

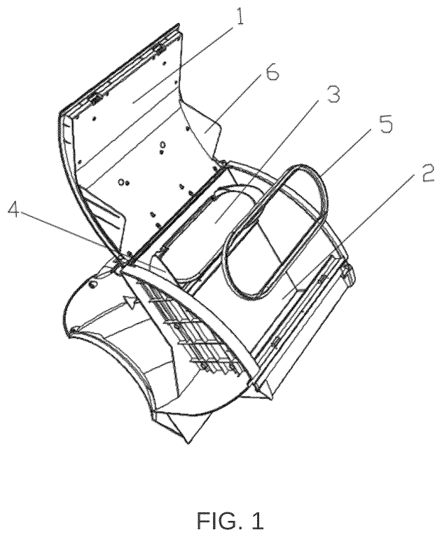

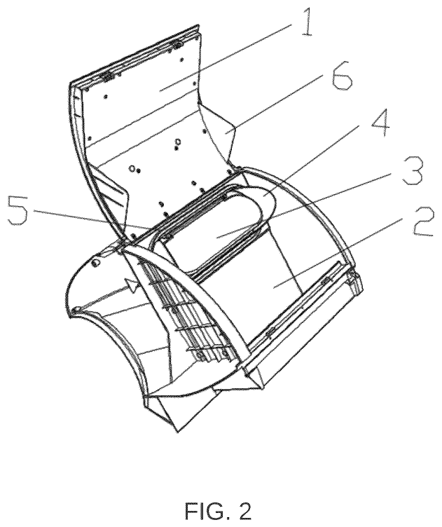

As shown in FIGS. 1 to 2, the present embodiment relates to a waste collection compartment for a cat litter box, including a waste compartment lid 1 and a waste compartment body 2. The waste compartment lid 1 is an arc-shaped lid plate, and is movably connected to the waste compartment body 2. Two buckles are provided at a bottom edge of the waste compartment lid 1, and two buckle grooves are provided at corresponding positions of the waste compartment body 2. When the waste compartment lid 1 is closed downward, the two buckles are buckled into the buckle grooves, so that the waste compartment lid 1 covers the waste compartment body 2 to make the entire waste compartment 10 a closed space. Triangular sheets 6 are provided on both sides of the waste compartment lid 1, and the triangular sheets 6 on both sides are pressed against a magnetic attraction ring 5, thereby limiting a position of the magnetic attraction ring, improving sealing of the waste collection when the waste compartment lid is closed, and preventing odor from overflowing.

The waste compartment body 2 is a cavity hollow inside and is provided with a waste entrance having a rounded rectangular shape. When the litter is filtered and the waste is collected in the cat litter box, the waste enters the waste compartment through the waste entrance due to the gravity. The waste entrance is covered with a waste compartment door 3, one end of the waste compartment door 3 is fixed to one end of the waste entrance, and the other end of the waste compartment door 3 is naturally fitted with the other end of the waste entrance due to the gravity. The waste compartment door 3 has a shape same as that of the waste entrance, and has a bottom area larger than a cross-sectional area of the waste entrance, and thus the waste compartment door 3 can only be opened toward one side of the waste compartment, and the opening and closing of the waste compartment door 3 is used to control the in and out of the waste. In the present embodiment, a thickness of the waste compartment door 3 is designed to be 5 mm to 6 mm, whereas a thickness of a regular waste compartment door 3 is generally 2 mm to 3 mm, and the waste compartment door 3 is designed to be thicker to block odor in the present embodiment.

Protruding fins 4 are provided on left and right sides of the waste compartment door 3, and are triangular plastic sheets with a protruding middle and concave ends. Bottom edges of the fins 4 coincide with an edge contour line of the waste compartment door 3. In an actual use, an opening of the waste bag is sleeved on the two fins 4, and the fins 4 exert an effect of helping the bag opening to be opened. During the collection of the waste, after the waste compartment door 3 is opened, the waste can smoothly enter the waste bag through the opened bag opening. If the fins 4 are not provided, the waste bag opening loses support and becomes soft and weak, so that the bag opening cannot be opened normally, affecting the collection of the waste.

The magnetic attraction ring 5 is sleeved on outer edges of the two fins 4, is made of ABS plastic material, and includes a magnet inside. The magnetic attraction ring 5 is magnetically attracted to a bottom of the waste compartment, and during the rotation of the waste compartment, the magnetic attraction ring 5 does not fall off easily. In an actual use, openings of the waste bag at both ends are first covered over an inner side of the magnetic attraction ring, and then the magnetic attraction ring is sleeved on the edges of the two fins to press the waste bag.

A plurality of protrusions are provided on the waste compartment lid 1, and when the waste compartment lid 1 is closed, these protrusions press against the magnetic attraction ring 5. The protrusions are not independent workpieces, but a structural design of the waste compartment lid 1, the plurality of hard protrusions are added to the waste compartment lid 1, and when the lid is closed, these protrusions press against the magnetic attraction ring 5 to further limit the magnetic attraction ring 5, thereby fixing the waste bag to prevent the waste bag from leaving a set position during the collection of the waste.

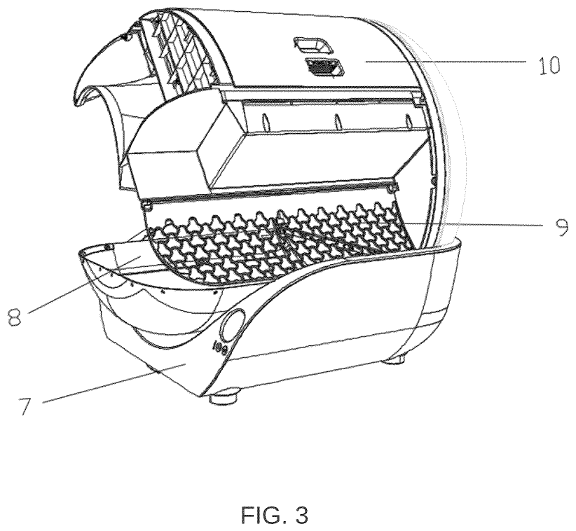

FIG. 3 shows a cat litter box with the waste collection compartment, which mainly includes a base 7, a cat compartment 8, a litter collection space 9, and a waste collection compartment 10. The cat compartment 8 is located on the base 7 and constitutes a body of the cat litter box, cat litter is laid in the cat compartment 8, and a cat defecates on the cat litter in the cat compartment 8. The cat compartment 8 and the litter collection space 9 are partitioned by a waste filter. The waste filter is a plate-shaped workpiece with a plurality of holes. When the litter is the filtered and the waste is collected, as the cat compartment 8 rotates, clean cat litter with a small aperture passes through the holes of the waste filter and enters the litter collection space 9 on the right, and clumped waste with a large aperture pushes and opens the waste compartment door 3 due to the gravity and enters the waste bag in the waste collection compartment 10.

A specific waste collection process and a working principle of the cat litter box according to the present embodiment are as follows.

First, the openings of the waste bag at both ends are covered over the inner side of the magnetic attraction ring, and then the magnetic attraction ring is sleeved on the edges of the two fins to press the waste bag. The waste compartment lid 1 is closed. After a cat finishes defecating, there are mainly three kinds of materials in the cat compartment 8, that is, clean cat litter with a small aperture that is not in contact with the waste at the bottom, clumped waste with a large aperture, and dirty clumped cat litter with a large aperture that are stained with urine. For the convenience of description, the clumped waste and the dirty clumped cat litter are collectively referred to as the clumped waste. In response to activation of a waste collection function, the cat compartment 8 rotates clockwise by a first predetermined angle, so that the cat litter enters the litter collection space 9 through holes, and the clumped waste passes through the waste compartment door 3 to enter the waste collection compartment 10. The cat compartment 8 rotates counterclockwise by a second predetermined angle, so that the clumped waste falls into the waste bag in the waste collection compartment 10, and the cat litter falls back into the compartment body. The first predetermined angle is smaller than the second predetermined angle, and the cat compartment 8 finally rotates clockwise to return to an original position.

Specifically, during the clockwise rotation of the cat compartment 8, the cat litter and the clumped waste move to the waste filter at the same time, the cat litter with a small aperture enters the litter collection space 9 through the holes, and the clumped waste with a large aperture stays on the waste filter, and continues to move to the waste compartment door 3 along with the rotation. When the waste compartment door 3 rotates to the bottom, the waste compartment door 3 is opened due to the gravity, and the clumped waste naturally falls into the waste bag in the waste collection compartment 10. After the clumped waste completely falls into the waste bag, the cat compartment 8 rotates counterclockwise by the second predetermined angle, the clumped waste falls into the waste bag to the bottom due to the gravity, the waste compartment door 3 loses thrust and returns to a closed state, and at the same time, the clean cat litter in the litter collection space 9 falls back into the cat compartment 8 due to the gravity.

Specifically, the first predetermined angle is 130° to 170°, such as 130°, 145°, 152°, and 160°. If the first predetermined angle is too small, the clumped waste cannot reach the waste compartment door 3 and cannot enter the waste collection compartment, and if the first predetermined angle is too large, the clumped waste that falls into the waste collection compartment 10 may fall out of the waste collection compartment 10 due to the gravity. Therefore, by setting the first predetermined angle to 130° to 170°, the clumped waste can smoothly enter the waste collection compartment 10 without escaping from the waste collection compartment 10 along with the subsequent rotation. The second predetermined angle is 140° to 180°, such as 140°, 155°, 162°, and 170°. In an actual use, the second predetermined angle is set to be 10° larger than the first predetermined angle. According to such a setting, the waste filter rotates counterclockwise to a certain height, so that the clean cat litter in the litter collection space 9 can fall back as fully as possible.

When the waste bag needs to be replaced, the waste compartment lid 1 is opened, the magnetic attraction ring 5 is removed, the opening of the waste bag is grasped to remove the waste bag from the fins 4. Since the opening of the waste bag is sleeved on the fins 4, an opening direction of the waste bag is always facing the inside of the waste compartment, and the inside of the waste bag cannot be seen during the replacement of the waste bag, thereby avoiding a mood of an owner from being affected by directly seeing the waste, so that a user experience is improved.

It should be noted that the solution described in the embodiment of the present application is merely one of implementation methods, and simple changes made on this basis should be regarded as a structure and an embodiment, similar to those of the technical solution, designed by those skilled in the art inspired by the present application without creativity and without deviating from the gist of the present utility model, which should fall within the protection scope of the present utility model.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

1. A waste collection compartment, comprising:
a waste compartment lid; and
a waste compartment body, wherein the waste compartment lid is an arc-shaped lid plate and is movably connected to the waste compartment body;
the waste compartment body is a cavity having a hollow inside;
a waste entrance is provided in the waste compartment body, wherein the waste compartment body has a rounded rectangular shape, and is covered with a waste compartment door;
one end of the waste compartment door is fixed to one end of the waste entrance, the other end of the waste compartment door is naturally fitted with the other end of the waste entrance due to the gravity;
protruding fins are provided on left and right sides of the waste compartment door; and
a magnetic attraction ring is sleeved on outer edges of the two fins.

2. The waste collection compartment according to claim 1, wherein each of the fins is a triangular plastic sheet with a protruding middle, concave ends, and a bottom edge of the fin coincides with an edge contour line of the waste compartment door.

3. The waste collection compartment according to claim 1, wherein the triangular plastic sheets are provided on both sides of an inner surface of the waste compartment lid; and
the triangular sheets are pressed into both sides of the waste compartment body and against the magnetic attraction ring when the waste compartment lid is closed.

4. The waste collection compartment according to claim 3, wherein a plurality of protrusions are provided on the inner surface of the waste compartment lid; and
the plurality of protrusions are pressed against the magnetic attraction ring when the waste compartment lid is closed.

5. The waste collection compartment according to claim 1, wherein the magnetic attraction ring is made of an Acrylonitrile Butadiene Styrene plastic material and includes a magnet inside the magnetic attraction ring.

6. The waste collection compartment according to claim 1, wherein a thickness of the waste compartment door is 5 mm to 6 mm.

7. A cat litter box, comprising:
a base;
a cat compartment;
a litter collection space;
the waste collection compartment according to any one of claims comprising:
a waste compartment lid; and
a waste compartment body, wherein the waste compartment lid is an arc-shaped lid plate and is movably connected to the waste compartment body;
the waste compartment body is a cavity having a hollow inside;
a waste entrance is provided in the waste compartment body, wherein the waste compartment body has a rounded rectangular shape, and is covered with a waste compartment door;
one end of the waste compartment door is fixed to one end of the waste entrance, the other end of the waste compartment door is naturally fitted with the other end of the waste entrance due to the gravity;
protruding fins are provided on left and right sides of the waste compartment door; and
a magnetic attraction ring is sleeved on outer edges of the two fins; and
wherein the waste collection compartment is located obliquely above the cat compartment.

8. The cat litter box according to claim 7, wherein the cat compartment and the waste collection compartment are connected by a channel partition.
